(19) United States
(12) Patent Application Publication
(10) Pub. No.: US 2019/0304622 A1
(43) Pub. Date: Oct. 3, 2019

(54) FLEXIBLE FLAT CABLE FOR TRANSMITTING HIGH-FREQUENCY SIGNALS

(71) Applicant: Bellwether Electronic Corp, Taoyuan City (TW)

(72) Inventors: Hsing-Yu Lee, Taoyuan City (TW); JIE-YAU TAN, Kaohsiung City (TW)

(21) Appl. No.: 16/297,721

(22) Filed: Mar. 11, 2019

(30) Foreign Application Priority Data
Mar. 28, 2018 (TW) 107204011

(51) Int. Cl. H01B 7/08; H01B 13/22

(52) U.S. Cl. CPC H01B 7/0861; H01B 13/22; H01B 7/0838

(57) ABSTRACT

A flexible flat cable for transmitting high-frequency signals includes an inner flat cable and a pair of shielding composite layers, which are divided into a main section, two connecting sections, and two sealing sections. The inner flat cable is disposed in the main section, and includes a plurality of conductors, an insulated glue layer, a pair of insulated partition layers and a pair of metallic shielding layers. The pair of insulated partition layers are disposed at two sides of the conductors and are affixed oppositely. The pair of metallic shielding layers are disposed at outer sides of the pair of insulated partition layers. Each shielding composite layer has a width larger than a width of the inner flat cable, and includes an outer shielding layer and a conductive glue layer having one part affixed to the inner flat cable and another part affixed to each other.

### CROSS-REFERENCE TO RELATED PATENT APPLICATION

This application claims the benefit of priority to Taiwan Patent Application No. 107204011, filed on Mar. 28, 2018. The entire content of the above-identified application is incorporated herein by reference.

Some references, which may include patents, patent applications, and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a flexible flat cable for transmitting high-frequency signals, and more particularly to a slim flexible flat cable being able to adjust a proper high-frequency structure, and enhance the shielding effect.

### BACKGROUND OF THE DISCLOSURE

With the development of technology, electronic elements are improved to be miniaturized and have high-frequency characteristics. Therefore, it has become an important issue to improve an effusion of internal noise, block the penetration of external noise and reduce the propagation of radio frequency interference.

In order to be thin, a conventional flexible flat cable usually uses a film shaping method to match the characteristic impedance. However, the metal layer formed by such a manner has an uneven thickness, even affecting the flatness. Further, a distance between the metal plating layer and the conductor is also uneven, and the resistance controlling is unstable, which cannot achieve better high-frequency characteristics.

In another conventional manner for achieving a better shielding effect, one signal metal layer is used to surround the flexible flat cable for shielding. However, the surrounding manner requires manpower, so that the conventional cable is not able to adapt mass production. Further, the surrounding manner always causes two side edges of the metal layer to be stacked to each other, or a connecting gap. In the high-frequency field, the impedance of the stacked part of the metal layer is hard to be well controlled. When the metal layer is bent, partial peeling-off is easily happened, which is not viewable and results in bad high-frequency characteristics. If a plurality of metal layers are used in the flexible flat cable, the flexible flat cable is hard to be thin.

Moreover, in the method of surrounding the metallic shielding layer around the flexible flat cable it is not easy to control a distance between the metallic shielding layer and signal conductors for transmitting high-frequency signals, which will cause an unpredictable change of high-frequency characteristics.

Even though two metal layers are respectively disposed at two sides of the flexible flat cable, to avoid the stacking problem of the metallic shielding layer, the lateral edges of the flexible flat cable still lack proper shielding, and may result in a penetration of electromagnetic interference and a propagation of RF (Radio Frequency) interference.

### SUMMARY OF THE DISCLOSURE

In response to the above-referenced technical inadequacies, the present disclosure provides a flexible flat cable for transmitting high-frequency signals, which can increase the stability of high-frequency characteristics based on the flexible characteristics, provide a full shielding effect, and reach automated production.

In one aspect, the present disclosure provides a flexible flat cable for transmitting high-frequency signals, which includes an inner flat cable and a pair of shielding composite layers. The flexible flat cable for transmitting high-frequency signals includes a main section, two connecting sections, and two sealing sections. The two connecting sections extend from two sides of the main section, and the two sealing sections extend from the two connecting sections. The inner flat cable is disposed in the main section, and includes a plurality of conductors, an insulated glue layer, a pair of insulated partition layers, and a pair of metallic shielding layers. The conductors include at least one pair of signal conductors for transmitting high-frequency signals, and at least one ground conductor. The insulated glue layers cover the conductors. The pair of insulated partition layers are respectively disposed at two sides of the conductors and are affixed oppositely by the insulated glue layer. The pair of metallic shielding layers is respectively disposed at outer sides of the pair of insulated partition layers. Each shielding composite layer has a width larger than a width of the inner flat cable, and covers the main section, the two connecting sections and the two sealing sections. Each shielding composite layer includes an outer shielding layer disposed at an outer side thereof, and a conductive glue layer disposed at an inner side thereof. The conductive glue layer has a part affixed to the inner flat cable and another part affixed to each other. The conductive glue layer is thoroughly extended to the main section, the two connecting sections, and the two sealing sections; the two sealing sections extend out of two side edges of the inner flat cable and are affixed to each other. The conductive glue layer in the main section is affixed to the metallic shielding layer of the inner flat cable. A distance from one side of the signal conductor for transmitting high frequency signal to the conductive glue layer at the same side is larger than at least 1.5 times of a distance from an upper side or a lower side of the signal conductor to a corresponding upper side or a corresponding lower side of the metallic shielding layer.

Therefore, the present disclosure has advantages as follows. The present disclosure provides the flexible flat cable for transmitting high-frequency signals, which includes the insulated partition layer coordinated with the uniformed metallic shielding layer. It therefore can adjust different high-frequency characteristics according to demands, and can enhance the stability of high-frequency characteristics based on the flexible characteristics, and achieve the thinning effect. The sealing section provides a shielding layer with a complete property so as to enhance the block of electromagnetic interference and reduce the propagation of Radio Frequency (RF) interference.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic front view of a flexible flat cable for transmitting high-frequency signals according to a first embodiment of the present disclosure.

FIG. 2 is a schematic front view of an inner flat cable of the flexible flat cable for transmitting high-frequency signals of the present disclosure.

FIG. 3 is a schematic view of manufacturing the flexible flat cable for transmitting high-frequency signals of the present disclosure.

FIG. 4 is a schematic lamination pressing view of the flexible flat cable for transmitting high-frequency signals of the present disclosure.

FIG. 5 is a schematic front view of a flexible flat cable for transmitting high-frequency signals of second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

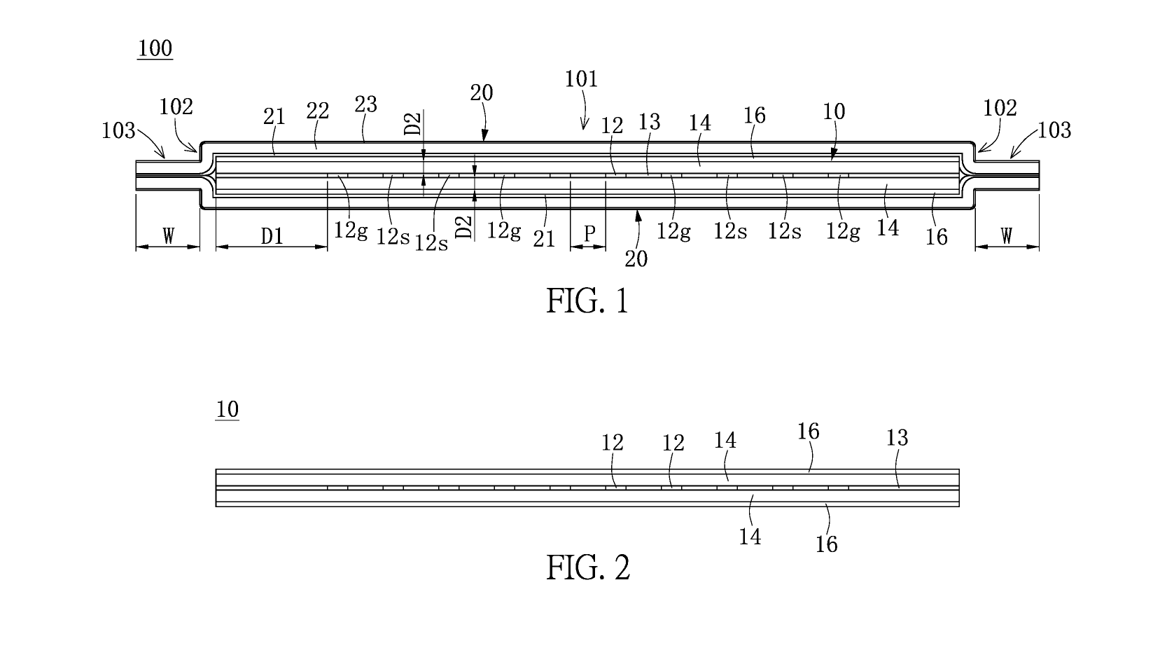

Reference is made to FIG. 1, which is a front view of a flexible flat cable for transmitting high-frequency signals of the present disclosure. The present disclosure provides a flexible flat cable 100 for transmitting high-frequency signals, or a flexible flat cable, which includes an inner flat cable 10 and a pair of shielding composite layers 20. In addition, the flexible flat cable 100 has a main section 101, two connecting sections 102, and two sealing sections 103 which extended in a horizontal direction, (or called a traverse direction) as shown in FIG. 1. The two connecting sections 102 are extended from two sides of the main section 101. The two sealing sections 103 are respectively extended from the two connecting sections 102.

The inner flat cable 10 is disposed in the main section 101. The inner flat cable 10 has a plurality of conductors 12, an insulated glue layer 13, a pair of insulated partition layers 14, and a pair of metallic shielding layers 16. The conductor 12 can be a tinned copper wire. The insulated glue layer 13 covers the conductors 12. The pair of insulated partition layers 14 are respectively disposed at two sides of the conductors 12 and are affixed to oppositely by the insulated glue layer 13. The insulated glue layer 13 can be made of, such as a thermoplastic resin, thermosetting resin or UV curable resin. The insulated partition layer 14 can be made of polyester resin, for example, Polyethylene Terephthalate (PET). The pair of insulated partition layers 14 are attached to two sides of the conductors 12 by the insulated glue layer 13. The pair of metallic shielding layers 16 are respectively disposed on an outside of the pair of insulated partition layers 14. The metallic shielding layer 16 is made of a metallic foil, with uniform thickness, such as an aluminum foil or copper foil. A constant distance is formed between the metallic shielding layer 16 and the conductors 12, so that the metallic shielding layer 16 can be a stable grounding for the conductors 12 and the resistant controlling is more stable. In this embodiment, the size of the metallic shielding layer 16 is designed to at least shield a pair of high-frequency signal conductors and an adjacent grounded signal conductor, so as to provide shielding function for improving the cross-talk between the pair of high-frequency signal conductors in the cable.

One of the characteristics of the present disclosure is that, a pair of shielding composite layers 20 are provided, and each shielding composite layer 20 has a width larger than a width of the inner flat cable 10. Each shielding composite layer 20 includes an insulated covering layer 23 arranged at an outermost side and a conductive glue layer 21 arranged at an innermost side. The conductive glue layer 21 has one part which is attached to the inner flat cable 10 and another part which is attached to each other. The conductive glue layer 21 can be an adhesive which has a certain conductivity after being solidified or dried. In this embodiment, the main composite material is made from a matrix resin and a conductive filler. The particles of the conductive filler are combined with the matrix resin, so as to form a conductive path. The conductive filler can be metal powder, graphite or conductive compound. The metal powder can be made of, such as gold, silver, copper, aluminum, zinc, iron, or nickel. The conductive glue layer 21 should have a certain thickness and cannot be too thin According to a practical embodiment, the thickness of the conductive glue layer 21 is preferably larger than 20 micrometer (μm).

In this embodiment, the conductive glue layer 21, which is positionally corresponding to the main section 101, is attached to an upper side and a lower side of the inner flat cable 10. In addition, the conductive glue layer 21, which is positionally corresponding to the sealing section 103, is attached to each other. Specifically, the conductive glue layer 21, which is positionally corresponding to the main section 101, is attached to the metallic shielding layer 16 of the inner flat cable 10. In this embodiment, the conductive glue layer 21 is disposed to correspond to the sealing section 103 on two outer sides of two edges of the inner flat cable 10, so as to provide a closer shielding function.

In this embodiment, each of the shielding composite layers 20 further has an outer shielding layer 22. The outer shielding layer 22 is arranged between the insulated covering layer 23 and the conductive glue layer 21. The outer shielding layer 22 can be a metal film or a metal weaved layer. However, the present disclosure is not limited thereto, for example, the insulated covering layer 23 can be omitted.

Specifically, according to one embodiment of the flexible flat cable for transmitting high-frequency signals 100, the conductive glue layer 21 is fully extended to the main section 101, two connecting sections 102 at two sides, and two sealing section 103 at two sides. The two sealing sections 103 extend beyond two lateral edges of the inner flat cable 10 and are attached to each other.

As shown in FIG. 1, according to one embodiment of the flexible flat cable for transmitting high-frequency signals 100, the two sealing sections 103 are aligned to the inner flat cable 10. In other words, the two sealing sections 103 and the inner flat cable 10 are arranged on the same level surface. From another aspect, the above shielding composite layer 20 and the lower shielding composite layer 20 has a symmetric bending manner. In detail, a thickness of the main section 101 is larger than a thickness of the sealing section 103. The connecting section 102 is curvedly bent from the main section 101, and the insulated glue layer 13 is formed with a height shift from the main section 101 toward the sealing section 103. However, the present disclosure is not limited thereto, for example, the lower shielding composite layer 20 can be planar and is not bent, and only two sides of the above shielding composite layer 20 are bent to attach with the lower shielding composite layer 20.

According to a practical test of the flexible flat cable for transmitting high-frequency signals 100 according to the present disclosure, a width W of the sealing section 103 can be 0.3 to 0.5 mm, therefore the shielding effectiveness at two sides of the inner flat cable 10 can be enhanced.

The above-mentioned structure of the flexible flat cable for transmitting high-frequency signals 100 is suitable to transmit high-frequency signals. Concerning the inner flat cable 10, the conductors 12 include at least one pair of signal conductors 12s for transmitting high-frequency signals, and at least one ground conductor 12g, in which at least one of the ground conductors 12g is disposed adjacent to the signal conductor 12s at its outer side. In this embodiment, two ground conductors 12g are arranged at two outer sides of the pair of signal conductors 12s, respectively. The ground conductors 12g are arranged adjacent to the connecting section 102 of the shielding composite layer 20.

In addition, the metallic shielding layers 16 of this embodiment are positionally corresponding to the main section 101 in an overall manner. In other words, the width of the pair of metallic shielding layers 16 are aligned to the width of the pair of insulated partition layers 14, so that the conductors 12 are completely shielded, such as the pair of high-frequency signal conductors, and adjacent one of the ground conductors, to provide shielding effectiveness for improving the cross-talk between high-frequency signal pair in the cable. However, the present disclosure is not limited thereto.

As shown in FIG. 1, a distance D1 from one edge of the signal conductor 12s used to transmit high-frequency signals to the conductive glue layer 21 at the same side is at least larger than 1.5 times of a distance D2. The distance D2 is measured from an upper/lower side surface of the signal conductor 12s to the metallic shielding layer 16 at the corresponding upper/lower side. Such a structure has advantages in that, a distance between the signal conductor 12s and the metallic shielding layer 16 is shorter, and the structure provides a stable ground reference on high-frequency transmission, to maintain a matching of characteristic impedance and stabilize a high-frequency characteristic. In addition, the conductive glue layer 21 can enhance the shielding function at sides of the conductors 12, so as to avoid a penetration of electromagnetic interference and a propagation of RF (Radio Frequency) interference.

In this embodiment, a plurality of conductors 12 has identical pitches P. From another viewpoint, the distance D1 from a side of the signal conductor 12s for transmitting high-frequency signal to the conductive glue layer 21 at the same side is between 0.5 to 2 times of Pitch P between two adjacent of the conductors.

The present disclosure further provides a process for manufacturing the flexible flat cable, which can be used for transmitting high-frequency signals. As shown in FIG. 2, an inner flat cable 10 is provided, and the inner flat cable 10 can be formed by dividing a wider flat cable.

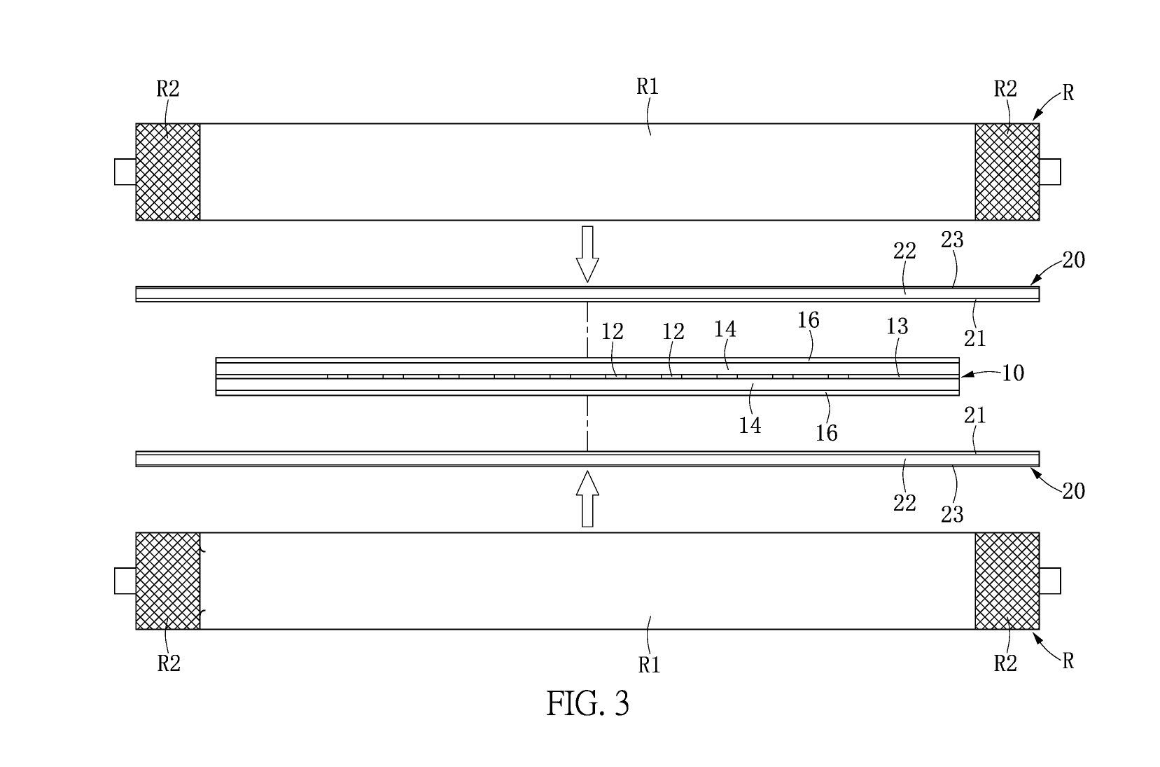

Afterward, referring to FIG. 3, a pair of shielding composite layers 20 are provided, which are disposed on a top side and a lower side of the inner flat cable 10. The insulated covering layer 23, the outer shielding layer 22, and the conductive glue layer 21 can be adhered together to become the shielding composite layer 20. Then, a pair of rollers R is provided. Each roller R has a middle roller R1 and two side rollers R2. Preferably, in the static condition that the roller R is not rolling, the middle roller R1 has an outer diameter which is equal to an outer diameter of the side roller R2. The middle roller R1 has an elastic modulus with a first strength, and the side roller R2 has an elastic modulus with a second strength. An elastic modulus of the side roller R2 is larger than an elastic modulus of the middle roller R1. In other words, a rigidity of the material of the side roller R2 is larger, the middle roller R1 is easily deformed with a larger elastic deformation when the middle roller R1 suffers from a force.

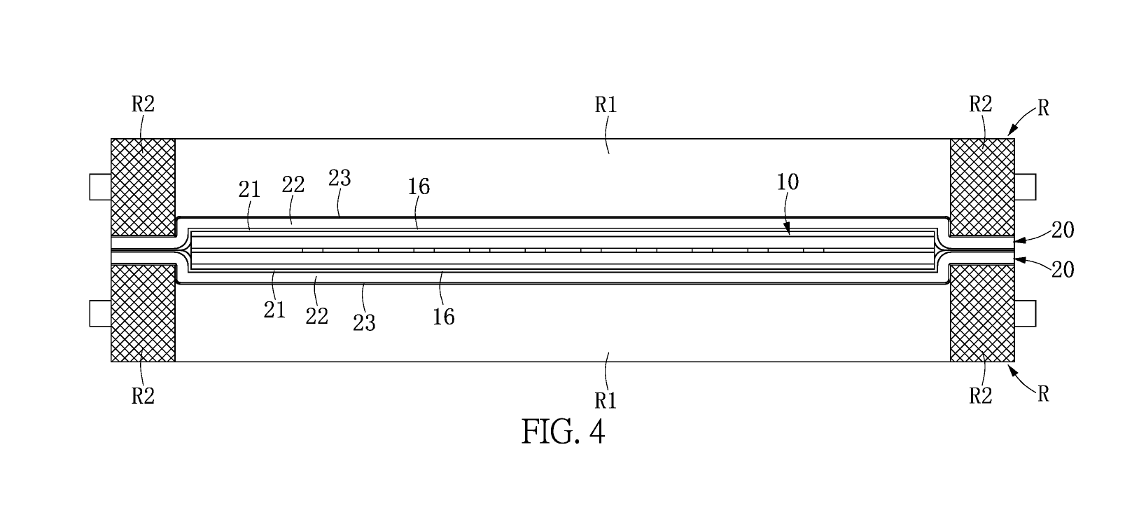

Reference is made to FIG. 4. A pair of rollers R is used to press the shielding composite layer 20 on an upper side and a lower side of the inner flat cable 10. According to the aforesaid processes, it is known that the flexible flat cable for transmitting high-frequency signals of the present disclosure is suitable for mass production. In this embodiment, the roller R with identical diameter is used, but the middle roller R1 and the side roller R2 have different elastic modulus. When a pressing force is exerted to laminate the flexible flat cable 100, the main section 101 has a larger thickness, and the middle roller R1 with a lower rigidity is deformed to maintain the same pressing force to laminate the main section 101. In addition, two side rollers R2 have larger rigidity, so as to ensure the tightness effect of the sealing section 103. On the contrary, if the middle roller and the side roller of the roller have a different diameter, the matched tolerance will easily cause an insufficient pressing force.

### Second Embodiment

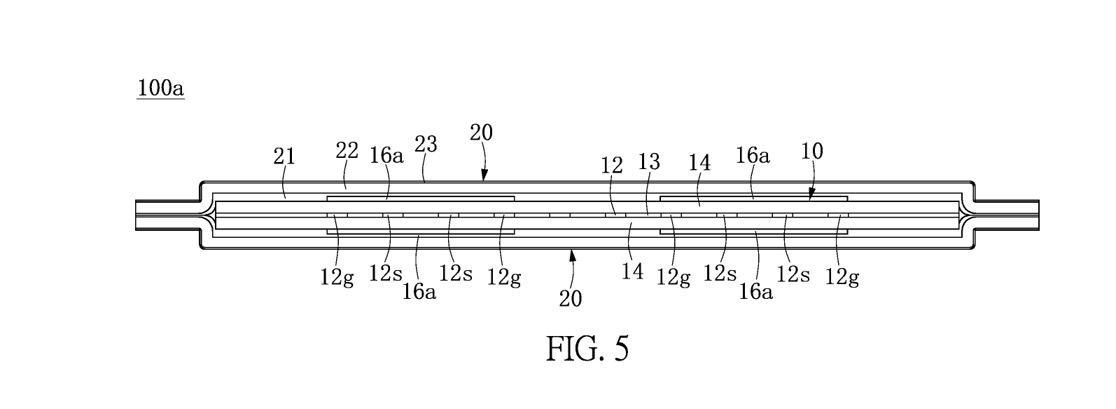

Referring to FIG. 5, which is a front view of the flexible flat cable for transmitting high-frequency signals of another embodiment according to the present disclosure. Different from the above embodiment, according to the flexible flat cable for transmitting high-frequency signals 100a of this embodiment, a width of the metallic shielding layer 16a is smaller than a width of the insulated partition layer 14. In addition, the metallic shielding layers 16a are arranged are an upper side and a lower side of the signal conductors 12s, which are used for shielding the conductors of transmitting high-frequency signals.

Specifically, this embodiment has two metallic shielding layers 16a disposed on the upper side of the insulated partition layer 14, which are correspondingly to shield four of the conductors 12, and another two metallic shielding layers 16a disposed on the lower side of the insulated partition layer 14, which are correspondingly to shield four of the conductors 12. The position and width of the upper two metallic shielding layers 16a correspond to that of the lower two metallic shielding layer 16a. An outer end of the outermost ground conductor 12g is aligned to an outer edge of the metallic shielding layer 16a.

In conclusion, the present disclosure has advantages as follows. The present disclosure provides the flexible flat cable for transmitting high-frequency signals, which includes the insulated partition layer 14 with a lower dielectric constant and a lower dielectric loss, and is coordinated with the uniformed metallic shielding layer (16 or 16a). It therefore can adjust different high-frequency characteristics according to demands, and the characteristic impedance of the differential signal pair of high-frequency signal conductors can be adjusted to between 70 to 110 ohms for adapting to the performance specifications of different high-frequency applications. The present disclosure can enhance the stability of high-frequency characteristics based on the flexible characteristics, and achieve the thinning effect. The thickness of the main section 101 can be controlled within 0.3 to 1.2 mm. The present disclosure further improves the manufacturing method to form the sealing section 103, which not only can provide a shielding layer with the complete property so as to enhance the block of electromagnetic interference and reduce the propagation of Radio Frequency (RF) interference, but also solve the problem of mass production. In addition, the present disclosure can stabilize the high frequency characteristics by controlling a distance from the signal conductors of transmitting high frequency to the metallic shielding layer to be shorter than a distance from the signal conductors of transmitting high frequency to a side edge of the conductive glue layer, which does not cause a harmful result due to incomplete shielding.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A flexible flat cable for transmitting high-frequency signals, comprising:
an inner flat cable, including a plurality of conductors, an insulated glue layer, a pair of insulated partition layers, and a pair of metallic shielding layers; wherein the plurality of conductors include at least one pair of signal conductors for transmitting high-frequency signals, and at least one ground conductor; the insulated glue layer covers the conductors, the pair of insulated partition layers are arranged at two sides of the conductors and are fixedly adhered by the insulated glue layer, the pair of metallic shielding layers are respectively arranged at outer sides of the pair of insulated partition layers; and
a pair of shielding composite layers, wherein the flexible flat cable for transmitting high-frequency signals is configured to have a main section, two connecting sections, and two sealing sections along a traverse direction, the two connecting sections are extended from two sides of the main section, the two sealing sections are respectively extended from the two connecting sections; wherein the inner flat cable is disposed in the main section;
wherein each of the shielding composite layers has a width larger than a width of the inner flat cable, and covers the main section, the two connecting sections and the two sealing sections; each of the shielding composite layers includes an outer shielding layer disposed at an outer side thereof, and a conductive glue layer disposed at an inner side thereof; a part of the conductive glue layer is affixed to a part of the inner flat cable, and another part of the conductive glue layers are affixed to each other;
wherein the conductive glue layer is thoroughly extended to the main section, the two connecting sections, and the two sealing sections; the two sealing sections extend out of two side edges of the inner flat cable and are affixed to each other;
wherein the conductive glue layer in the main section is affixed to the metallic shielding layer of the inner flat cable;
wherein a distance from a side of the signal conductor for transmitting high frequency signal to the conductive glue layer at the same side is larger than at least 1.5 times of a distance from an upper side or a lower side of the signal conductor to a corresponding upper side or a corresponding lower side of the metallic shielding layer.

2. The flexible flat cable according to claim 1, wherein each of the shielding composite layers further includes an insulated covering layer which is disposed at an outermost side thereof, the outer shielding layer is disposed between the insulated covering layer and the conductive glue layer.

3. The flexible flat cable according to claim 1, wherein the two sealing sections are aligned to the inner flat cable.

4. The flexible flat cable according to claim 1, wherein a thickness of the main section is larger than a thickness of the sealing section, the connecting section is bent and extends from the main section, the insulated glue layer extends from the main section toward the sealing section to form a drop height.

5. The flexible flat cable according to claim 1, wherein a width of the sealing section is between 0.3 to 0.5 mm.

6. The flexible flat cable according to claim 1, wherein at least one of the ground conductors is adjacent to an outer one of the signal conductors, and is adjacent to the connecting section of the shielding composite layer.

7. The flexible flat cable according to claim 6, wherein a characteristic impedance of the differential signal pair of high-frequency signal conductors is between 70 to 110 ohms, a thickness of the main section is between 0.3 to 1.2 mm.

8. The flexible flat cable according to claim 1, wherein the pair of metallic shielding layers have a width matched with a width of the pair of insulated partition layers, and thoroughly shield the conductors.

9. The flexible flat cable according to claim 1, wherein a width of the metallic shielding layer is smaller than a width of the insulated partition layer, and shields the conductor of transmitting high frequency signals.
